(19) United States
(12) Patent Application Publication
(10) Pub. No.: US 2020/0041323 A1
(43) Pub. Date: Feb. 6, 2020

(54) METHOD FOR MEASURING THE QUANTITY OF GAS INTRODUCED INTO A RESERVOIR AND CORRESPONDING FILLING STATION

(71) Applicant: L'Air Liquide, Societe Anonyme pour l'Etude et l'Exploitation des Procedes Georges Claude, Paris (FR)

(72) Inventor: Thibaut FRANCOIS, Fontanil Cornillon (FR)

(73) Assignee: L'Air Liquide, Societe Anonyme pour l'Etude et l'Exploitation des Procedes Georges Claude, Paris (FR)

(21) Appl. No.: 16/603,437

(22) PCT Filed: Mar. 29, 2018
(86) PCT No.: PCT/FR2018/050767

§ 371 Date: Oct. 7, 2019

(30) Foreign Application Priority Data
Apr. 7, 2017 (FR) 1753046

(51) Int. Cl. G01F 13/00; G01F 15/00; F17C 5/06; F17C 13/02

(52) U.S. Cl. CPC G01F 13/006; G01F 15/002; F17C 5/06; F17C 13/02; F17C 2221/012; F17C 2225/0123; F17C 2270/0168; F17C 2227/044; F17C 2250/043; F17C 2250/0443; F17C 2250/0636; F17C 2260/024; F17C 2265/065; F17C 2225/036

(57) ABSTRACT

A measured quantity of gas is introduced into a gas reservoir via a filling station including a flow meter. The quantity of gas transferred by the filling station to the reservoir is measured by the flow meter. The measured quantity of gas is reduced or increased by a predetermined corrective amount to yield a corrected gas quantity.

### CROSS-REFERENCE TO RELATED APPLICATIONS

This application is a § 371 of International PCT Application PCT/FR2018/050767, filed Mar. 29, 2018, which claims § 119(a) foreign priority to French patent application FR 1753046, filed Apr. 7, 2017.

### BACKGROUND

### Field of the Invention

The invention relates to a method for measuring the quantity of gas introduced into a tank, and to a filling station.

The invention relates more particularly to a method for measuring the quantity of gas introduced into a gas tank via a filling station provided with a filling pipe comprising an upstream end connected to at least one source of pressurized gas and a downstream end connected to a tank that is to be filled, the filling pipe comprising a flow meter and at least a downstream isolation valve positioned between the flow meter and the downstream end of the filling pipe, the method comprising a step of transferring gas from the source to the tank, during which step the downstream isolation valve is open, a step of interrupting the transfer of gas with closure of the downstream valve, the method comprising a step of measuring, using the flow meter, the quantity of gas transferred during the transfer step.

### Related Art

Filling stations for filling pressurized-gas tanks, notably the fuel-gas tanks of vehicles, need to measure the quantity of gas introduced into the tank with a relatively high level of precision. This is particularly true of the filling of pressurized hydrogen-gas tanks.

This quantity needs to be measured (metered) so that a charge can be made for it (in the same way as a liquid fuel).

In the case of a gas, for example hydrogen, there are many parameters that influence the measurement of this quantity (pressure, temperature, volume, flow rate . . . ).

This quantity is dependent in particular on the initial conditions (notably the pressure in the tank prior to filling) and the final conditions (notably the pressure after filling). This quantity is also difficult to measure because in general a quantity of gas present in the circuit is purged to the outside after filling. The purpose of this purge is to lower the pressure in the hose of the filling pipe in order to allow the user to disconnect the end of the filling pipe from the tank.

Ideally, the flowrate of gas transferred should be measured as close as possible to the tank (at the filling nozzle). However, for industrial and technical reasons, this flow rate measurement is in fact performed further upstream. Thus, some of the gas measured by the flow meter is not transferred into the tank and there is a risk that a charge will be made to the client for it.

In order to measure, as correctly as possible, the quantity of gas transferred (and therefore chargeable) it is known practice not to count the gas, if any, injected during the pre-filling test (pulses of gas may in fact be used for leak testing and/or for calculating the volume of the tank or other parameters).

### SUMMARY OF THE INVENTION

It is an object of the invention to propose a method and/or a device that makes it possible to improve the precision with which this quantity of gas actually supplied to the tank is measured.

It is an object of the present invention to alleviate all or some of the above-mentioned disadvantages of the prior art.

To this end, the method according to the invention, in other respects in accordance with the generic definition thereof given in the above preamble, is essentially characterized in that it comprises a step of generating a signal indicating the corrected quantity of gas transferred, the corrected quantity of gas transferred being obtained by reducing or by increasing, by a determined corrective quantity, the transferred quantity of gas measured by the flow meter during the transfer step.

Moreover, embodiments of the invention may comprise one or more of the following features:
the flow meter is of the type that generates electric signals in the form of successive pulses each corresponding to an elementary measured quantity of gas, the generation of a signal indicating the corrected quantity of gas transferred being obtained by a step of modifying at least one of the following: the value of the elementary quantity of gas corresponding to a pulse generated by the flow meter and/or the number of pulses generated by the flow meter and/or the frequency with which the pulses generated by the flow meter are emitted and/or the number of pulses counted from the pulses generated by the flow meter,
the generation of a signal indicative of the corrected quantity of gas transferred is obtained by subtracting, or by adding, a determined quantity of pulses from or to the pulses generated by the flow meter,
the modification step is performed by modifying (up or down) the frequency of the pulses generated by the flow meter, namely by removing or by adding a determined length of time from or to the time interval separating successive pulses generated by the flow meter,
the determined corrective quantity of gas is a determined proportion of the quantity of gas measured by the flow meter during the transfer step,
the determined proportion is fixed, which is to say independent of the operating conditions of the filling step, or variable, which is to say dependent on the operating conditions of the filling step,
the filling pipe comprises, downstream of the downstream isolating valve, a controlled purge valve, the method comprises a step of purging to outside the filling pipe at least some of the pressurized gas trapped in the downstream part of the filling pipe after the transfer step,
the determined corrective quantity of gas is a determined percentage of the quantity of gas discharged during the purge step,
the percentage, which varies according to the operating conditions of the filling step and notably according to the pressure measured in the transfer line during the transfer step, said percentage being calculated regularly during the filling step and notably at the end of the transfer step,
the percentage is proportional to the pressure in the transfer line,
the percentage is comprised between 100% and 0% and preferably between 95% and 75%,
the filling pipe comprises a purge flow meter configured to measure the quantity of gas discharged during the purge step,
the modification step is performed during the transfer step,
that the modification step is performed regularly, spread in time over the course of the transfer step,
the modification step is performed at the end or after the end of the transfer step,
the filling station comprises an electronic data processing and storage device, notably comprising a microprocessor and/or computer, said electronic device being configured to receive a signal indicative of the quantity of gas transferred as measured by the flow meter during the transfer step and to calculate and/or receive and/or transmit and/or display the signal indicating the corrected quantity of gas transferred,
the operating conditions of the filling step comprise at least one of the following: the duration of the transfer step, the measured or estimated pressure in the filling pipe before the transfer step, the measured or estimated pressure in the filling pipe during the transfer step, the measured or estimated pressure in the filling pipe at the end of the transfer step, the measured or estimated pressure in the filling tank before the transfer step, the measured or estimated pressure in the filling tank during the transfer step, the measured or estimated pressure in the filling tank at the end of the transfer step, the temperature of the gas in the transfer pipe, the temperature of the gas in the tank, the volume of the transfer pipe downstream of the downstream isolation valve, the measured or estimated quantity of gas vented during a phase of purging the transfer pipe after the transfer step,
in the event that the corrected quantity of gas transferred consists in reducing, by a determined corrective quantity, the quantity of gas transferred as measured by the flow meter during the transfer step, this reduction is performed by eliminating and/or by not including in the count certain determined pulses from among the pulses generated by the flow meter,
the corrective quantity is dependent on at least one of the following parameters: the measured or estimated pressure in the filling pipe before the transfer step, the measured or estimated pressure in the filling pipe during the transfer step, the measured or estimated pressure in the filling pipe at the end of the transfer step, the measured or estimated pressure in the filling tank before the transfer step, the measured or estimated pressure in the filling tank during the transfer step, the measured or estimated pressure in the filling tank at the end of the transfer step, the temperature of the gas in the transfer pipe, the temperature of the gas in the tank, the volume of the transfer pipe downstream of the downstream isolation valve, the measured or estimated quantity of gas vented during a phase of purging the transfer pipe after the transfer step,
the proportion is dependent on the final pressure in the tank or in the transfer line,
the pressure in the tank or in the filling pipe during or at the end of the transfer step is measured or estimated, the determined corrective quantity being a quantity which varies according to (preferably solely according to) this pressure,
the determined corrective quantity of gas is subtracted from the measured quantity of gas transferred and is comprised between 11 and 5 grams when the pressure in the tank that is to be filled or in the filling pipe is comprised between 850 and 700 bar and comprised between 8 and 2.5 grams when the pressure in the tank that is to be filled or in the filling pipe is comprised between 700 and 400 bar, and comprised between 6 and 1 gram when the pressure in the tank that is to be filled or in the filling pipe is comprised between 400 and 200 bar,
the determined corrective quantity of gas is a quantity which varies according to the temperature of the gas in the tank that is to be filled or in the filling pipe,
the determined percentage (%) of the quantity of gas removed during the purge step and that defines the corrective quantity, is given by the formula

%=(P−Pi)/(Pm−Pi)

in which P is the pressure in the filling pipe during or at the end of the transfer step, Pi is the final pressure in the transfer line after the discharge step, Pm being a determined reference value such as the maximum working pressure in the transfer line, Pm being comprised between 500 and 1000 bar and preferably between 700 and 900 bar, for example equal to 875 bar, the pressure values being expressed for example in the bar or in Pa,
the determined corrective quantity of gas is calculated by a state equation for the gas and notably using the perfect-gas or real-gas equation applied to the gas in the downstream part of the filling pipe before the purge step and after the purge step on the basis of the following parameters: the known volume of the filling pipe downstream of the downstream isolation valve, the measured final pressure in the tank that is to be filled or in the filling pipe during or at the end of the transfer step and before the purge step, the measured or estimated temperature of the gas in the tank that is to be filled or in the filling pipe, the known nature of the gas and notably its molar mass, the pressure in the filling pipe after the purge step, the corrective quantity being the result of the difference between the quantity of gas present in the downstream part of the filling pipe before the purge step and the quantity of gas present in the in the downstream part of the filling pipe after the purge step,
the determined corrective quantity of gas is a fixed quantity.

The invention also relates to a filling station for filling tanks with pressurized fluid, notably for filling tanks with pressurized hydrogen, comprising a filling pipe comprising an upstream end connected to at least one source of pressurized gas and at least one downstream end intended to be connected to a tank that is to be filled, the filling pipe comprising a flow meter and at least one downstream isolation valve positioned between the flow meter and the downstream end of the filling pipe, the at least one valve being operated in such a way as to allow a step of transferring gas from the source to the tank, the flow meter being configured to measure the quantity of gas transferred and to generate in response a corresponding signal, the station comprising an electronic data processing and storage device, notably comprising a microprocessor and/or computer, the electronic device being configured to receive the signal from the flow meter and to generate a signal indicative of the corrected quantity of gas transferred, this being obtained by reducing or by increasing, by determined corrective quantity, the quantity transferred of gas as measured by the flow meter during the transfer.

The invention may also relate to any alternative device or method comprising any combination of the features above or below.

In particular, the electronic device may be configured to perform all or some of the actions above or below.

### BRIEF DESCRIPTION OF THE FIGURES

Other distinguishing features and advantages will become apparent on reading the description below, made with reference to the figures, in which:

FIG. 1 is a schematic and partial view illustrating one example of a structure and operation of a filling station according to a first possible exemplary embodiment of the invention,

FIG. 2 is a schematic and partial view illustrating one example of a structure and operation of a filling station according to a second possible exemplary embodiment of the invention.

### DETAILED DESCRIPTION OF THE INVENTION

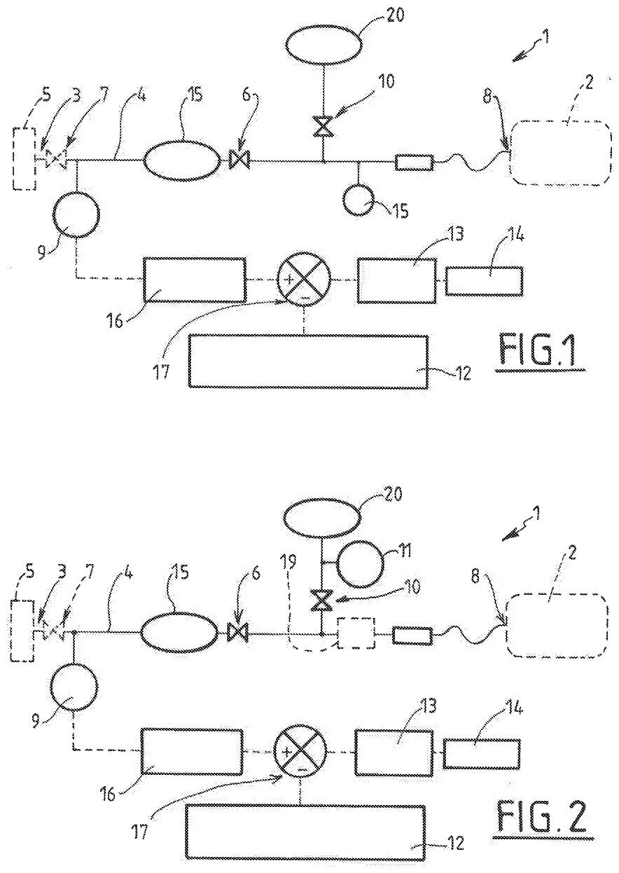

The filling station for filling tanks with pressurized fluid as schematically indicated in FIG. 1 conventionally comprises a filling pipe 4 comprising at least one upstream end 3 connected to at least one source 5 of pressurized gas and at least one downstream end 8 intended to be connected to a tank 2 that is to be filled.

The source of gas (notably hydrogen) may comprise at least one of the following: one or more tanks of pressurized gas, notably several tanks connected in parallel for cascade filling, a compressor, a source of liquefied gas and a vaporizer, and/or any other appropriate source of pressurized gas.

The downstream end 8 comprises for example at least one flexible hose, the terminal end of which comprises a coupling, preferably a quick coupling, allowing it to be connected in a sealed manner to the inlet of a tank 2 or of a filling circuit for filling a tank 2 (notably of a vehicle).

The filling pipe 4 comprising a flow meter 9 and at least one downstream isolation valve 6 positioned between the flow meter 9 and the downstream end 8 of the filling pipe 4. The isolation valve 6 is preferably an operated valve 6 controlled in such a way as to allow a step of transferring gas from the source 5 to the tank 2 when this valve is open.

The flow meter 9 is preferably of the Coriolis-effect type and is configured to measure the transferred quantity of gas and to generate a corresponding (preferably electrical) signal.

The station 1 comprises an electronic data processing and storage device 12, comprising for example a microprocessor and/or a computer. This electronic device 12 is configured to receive the signal from the flow meter 9 and to generate a signal indicating the corrected quantity of gas transferred which is obtained by reducing or increasing, by a determined corrective quantity, the measured quantity of gas transferred, as measured by the flow meter 9 during transfer.

For preference, the electronic device 12 can be configured to control all or some of the valves 6, 10 or components of the station and/or to receive pressure 15 and/or temperature measurements taken by one or more sensor(s) in the filling circuit 4 (upstream and/or downstream of the downstream isolation valve 6. In particular, the electronic device 12 may preferably be configured to control the transfer of gas to the tank 2 (control the flow rate and/or the sources . . . ) according to a predetermined flow rate (fixed and/or variable pressure gradient).

In addition, the electronic device 12 may comprise or be associated with a man-machine interface comprising, for example, a display 13 and/or a payment terminal 14 and/or an input and/or identification member. The electronic device 12 may comprise wireless communication members for transmitting or receiving these data and/or other data. In particular, all or part of the data storage and/or computing and/or display and/or invoicing means may be sited away from the station or duplicates sited remotely (via the Internet or local network and using, for example, mobile telephone applications).

As illustrated, the filling pipe 4 also preferably further comprises a purge valve 10 situated downstream of the downstream isolation valve 6.

The purge valve 10 is preferably controlled in such a way as to discharge to outside the filling pipe 4 at least some of the pressurized gas trapped in the downstream part of the filling pipe 4 after a transfer step (at the end of a filling operation). The purge gas is discharged into the atmosphere or into a recovery zone 20.

By reducing or increasing, by a corrective quantity, the measured quantity of gas transferred as measured by the flow meter 9 during the transfer step it is thus possible to display and/or to charge the user for a quantity of gas which is closer or equal to the quantity of gas actually transferred into the tank 2.

For preference, the flow meter 5 is of the type that generates electrical signals in the form of successive pulses each one corresponding to a measured elementary quantity of gas (for example one gram or three grams or “x” grams per pulse). What that means to say is that, each time the flow meter measures the passage of a quantity (for example one gram) of gas, it emits a pulse. The flow rate corresponds to the number of pulses per unit time (for example a certain number of grams of gas per minute).

The generation of a signal indicating the corrected quantity of gas transferred may be obtained by a step of modifying at least one of the following: the value of the elementary quantity of gas corresponding to a pulse generated by the flow meter 5 and/or the number of pulses generated by the flow meter 5 and/or the frequency with which the pulses generated by the flow meter 5 are emitted and/or the number of pulses counted from the pulses generated by the flow meter 5.

The generation of a signal indicative of the corrected quantity of gas transferred may notably be obtained by subtracting, or by adding, a determined quantity of pulses from or to the pulses generated by the flow meter. The subtracting of pulses may be achieved for example by not taking certain pulses into consideration (by not including them in the count).

For example, the determined corrective quantity of gas is a determined proportion of the quantity of gas measured by the flow meter 5 during the transfer step.

For example, only a percentage of pulses is subtracted, or not included in the count, or added to the pulses generated by the flow meter 9. This percentage (or corrective quantity) is preferably dependent on the pressure in the filling pipe 4 during and/or at the end of the gas transfer step.

The quantity of gas purged after filling (after a gas transfer step) is essentially dependent on the final pressure in the withdrawing pipe 4. This final pressure is dependent on the maximum working pressure of the tank (for example 200 bar or 300 bar or 700 bar or 875 bar or an intermediate or higher value).

According to one advantageous embodiment, the determined corrective quantity of gas is a determined percentage of the quantity of gas discharged during the purge step. This percentage may be fixed arbitrarily or calculated according to the operational conditions of the filling.

The corrective quantity is, for example, dependent on (notably proportional to) the current and/or final pressure in the transfer line 4 during the transfer of the gas.

For example, it is possible to define a proportional relationship between:
the current pressure P (measured regularly) in the transfer line 4 during the transfer step,
the total number Nf of pulses generated by the flow meter 9 at the instant of the transfer step under consideration,
the percentage (%) of pulses not included in the count/eliminated/added,
the corrected number Ncorrect of pulses (after calculating the corrected quantity of gas transferred),
the quantity Ni of pulses corresponding to the quantity of gas purged during a purge step following immediately after a transfer step.

This quantity Ni of pulses corresponding to the quantity of gas purged during a purge step may be calculated or measured or predefined arbitrarily. This quantity Ni of pulses corresponding to the quantity of gas purged during a purge step is dependent for example:
on the (known) volume of the filling pipe 4 purged,
on the final maximum pressure Pm permitted in the filling pipe 4 (or on a determined maximum reference pressure), for example comprised between 500 and 1000 bar, and preferably between 700 and 900 bar, for example equal to 875 bar,
the final pressure Pi in the filling pipe 4 after the discharge (purge) step, this pressure being measured or estimated and, possibly, predefined, for example at a few bar, notably 3 bar,
the measured or estimated temperature of the gas in the filling pipe 4.

For example, the percentage (%) of pulses not included in the count/eliminated may be given by the following formula:

%=(P−Pi)/(Pm−Pi)

in which P is the current pressure in the filling pipe 4 during the transfer step, Pi is the final pressure in the transfer line after the discharge/purge step, Pm being the determined reference value such as the maximum working pressure in the transfer line 4, for example equal to 875 bar.

Thus, by determining this percentage % (either fixed beforehand or in real time), it is possible to define the corrected number Ncorrect of pulses as being the difference between the total number Nf of pulses generated by the flow meter 9 and the product of the percentage times the quantity Ni of pulses corresponding to the quantity of gas purged:

Ncorrect=Nf−%·Ni

In one possible exemplary embodiment, at the start of filling, the conditions may be as follows: P=0 bar, Pi=3 bar, Pm=875 bar hence %=2 percent, Nf is for example equal to one hundred pulses (the total quantity of gas to be transferred is pre-defined as being equal to 100 measured pulses), and Ni is equal to three pulses.

During the course of filling, the conditions may be as follows: P=400 bar, Pi=3 bar, Pm=875 bar hence %=46 percent, Nf=one hundred pulses, and Ni is equal to three pulses. So, Ncorrect=between 98 and 99 pulses. What that means to say is that the correction involves subtracting one to two pulses.

Later on in the course of filling, the conditions may be as follows: P=750 bar, Pi=3 bar, Pm=875 bar hence %=86 percent, Nf=one hundred pulses, and Ni is equal to three pulses. So, Ncorrect=around 97 pulses. What that means to say is that the correction involves subtracting three pulses.

Of course, the percentage is not limited to the expression above and could be a determined value predefined according to the pressure P in the filling pipe 4 at the start or end of filling, or according to a reference value independent of the pressure in the filling pipe 4.

Likewise, the percentage could be a determined value predefined according to the pressure differential (P0−Pi) between the pressure P0 in the transfer line 4 before the transfer step and the pressure (Pi) in the transfer line as measured during the course of the transfer step and/or the end of the transfer step.

The quantity Ni of pulses corresponding to the quantity of gas purged during a purge step may be predetermined and quantified by measurement according to the operating conditions or by calculation (gas state equation, thermodynamic equations).

Thus, by knowing Nf, % and Ni, the station can adjust continuously during the transfer of gas (and/or at the end of the transfer of gas) the corrected quantity of gas transferred, which is that for which a charge will be actually be made/that which will actually be taken into consideration.

The advantage of making this adjustment continuously throughout the transfer step (rather than at the end of the transfer step) is that a precise measurement is available (displayed) in real time so that if appropriate, information can be delivered that does not experience a variation when the filling stops.

In particular, if the user wishes to stop transferring gas when a certain pressure level or gas quantity or chargeable value is displayed, the continuous adjustment will not modify the quantity of gas displayed/for which a charge is made at the end of filling.

On the other hand, if the adjustment is made at the end of the gas transfer, the quantity of gas displayed in real time may be subject to variation after stopping. This could come as a surprise to a user who is specifically wishing to stop a gas transfer according to a precise chargeable-quantity-of-gas indication reached.

This adjustment may be performed continuously in each predetermined-time time interval (second), and/or for each predetermined pressure interval (bar) in the tank and/or each predetermined quantity of pulses, or in real time.

For example, the adjustment may consist in subtracting ten percent of gas from the quantity of gas measured by the flow meter 9. If the flow meter 9 generates one pulse for every ten grams measured, and if one kilogram of gas is transferred, the signal generated by the flow meter will contain one hundred pulses (10 g×100=1000 g). In that case, the 10% adjustment involves subtracting (not counting) ten pulses. These ten pulses may be subtracted at the end (the final ten) or regularly, one pulse in every ten generated during the course of the transfer step.

The remaining ninety pulses (10 g×90=900 grams) constitute the corrected quantity of gas transferred and actually transferred or chargeable.

Thus, the corrective quantity of gas may be known at each pressure level during the filling. For each gram of gas measured by the flow meter 9, a small percentage (for example two to fifteen percent) may be considered not to have been introduced into the tank 2 but purged.

Instead of removing (not counting)/adding pulses from/to those measured by the flow meter 9, it is also possible to alter another parameter such as the phase or frequency modulation of the pulses. Thus, the interval of time between the pulses may act as an adjustment variable in order to arrive at the corrected quantity of gas.

Thus, it is possible to “reconstruct/modify” the frequency of the pulses generated by the flow meter 9 in order to take this correction into account.

For example, if one hundred pulses are generated by the flow meter 9 in a time D, these are reprocessed (by signal processing) into ninety pulses uniformly distributed over the same time D.

The time added or subtracted between two pulses can be determined so that it corresponds to the corrected quantity of gas.

What that means to say is that the Ncorrect pulses are “redistributed” evenly during the predefined filling duration.

The filling time D may be defined/estimated beforehand (before filling) according to the initial pressure in the tank 2, to the intended rate of pressure rise (predefined pressure gradient) and to the desired final pressure.

For example, for a 122-liter tank, and a pressure gradient of 218 bar/minute, and a target pressure of 819 bar, the filling time D is 3 minutes and 15 seconds (injected quantity is 4.2 kg, and the filling temperature is −33° C.). These filling conditions are defined, as appropriate, by standardized conditions.

The connection between the time added or removed between the pulses measured by the flow meter 9 may be based on:
the estimated or calculated duration of the filling, which can be broken down into determined intervals (Delta t),
the determined volume of the filling pipe 4 that is intended to be purged, this volume, associated with the pressure before the purge, makes it possible to define the quantity Ni of pulses that correspond to the quantity of gas purged,
it is then possible to make the quantity of gas that is to be purged correspond to the equivalent duration of the corresponding Ni pulses.

In effect, the variation in pressure multiplied by the duration defines the pressure reached. Because the pressure is known, it makes it possible to determine the density of the gas using a state equation (measured temperature or assumed known temperature). The density multiplied by the volume that is to be purged defines the quantity (mass) of gas that is to be purged, and therefore defines Ni.

This duration can be divided by the estimated duration D of the filling and distributed for each of the calculated time intervals (Delta t). Thus, a time (t1) is added to (or subtracted from) each interval (Delta t). The frequency of the pulses generated is therefore modified in order continuously to take account of the corrective quantity of gas that is to be added/subtracted.

Thus, for example, for the one same filling duration D and n pulses measured by the flow meter 9 which are separated by a time interval (Delta t) between two pulses (n being an integer>0), can be modified into m pulses (m being an integer>0 and m<n), separated by an increased time interval (Delta t+t1) between two pulses.

In the event that a corrective quantity of gas has to be added, there might be, after adjustment, q pulses (q being an integer>0 and q>n), separated by a reduced time interval (Delta t−t1) between two pulses.

To simplify the process, all or some of the parameters of filling (time) D, quantity of gas transferred, ambient temperature, temperature of the gas in the filling pipe 4, pressure in the filling pipe 4 before the transfer step, final temperature in the filling pipe 4 the end of the transfer step . . . ) may be fixed beforehand according to conditions deemed to be standard.

The corrected quantity of gas transferred would then be calculated on the basis of these fixed conditions. This notably makes it possible to limit the number of parameters that need to be measured and therefore the number of devices the operation of which needs to be certified.

Likewise, in another possible embodiment, the value of the individual quantity of the pulses may serve as an adjustment variable for arriving at the corrected quantity of gas.

For example, the pulses are no longer generated for each gram, but for each 1.1 gram of gas measured.

For preference, in that case, the known value for the volume of the tank 2 that is to be filled is used.

The precision of the correction may be tailored to a type of tank 2 (particularly to a volume).

This adjustment is also adapted when the station 1 is modified (notably in terms of the volume of the filling pipe 4).

Thus, the corrective quantity of gas may be defined or predefined for each increase in pressure in the tank 2 being filled (and, if need be, according to other parameters such as the temperature of the gas).

Another option is for the determined corrective quantity of gas to be a fixed quantity (for example a determined mass of gas) irrespective of the filling conditions.

For example, the determined corrective quantity is comprised between ten and two grams, and preferably between nine and six grams.

For example, the corrective quantity will be independent of the final pressure at the end of the gas transfer step. This quantity will be preestablished for maximum filling-pressure conditions (200 bar, 350 bar or 700 bar for example). In that case, there is no need to provide a pressure sensor 15 in the measurement and calculation loop or there is no need to use such a measurement in calculating the corrective quantity.

As an alternative or in combination, this corrective quantity is a fixed quantity or a (fixed or variable) percentage which is dependent on (varies according to) the filling conditions, and, for example, the final pressure.

Thus, in the event that different tanks 2 are filled at different pressures, the determined corrective quantities may be different.

The determined corrective quantity may correspond to a predetermined value corresponding to determined thermodynamic conditions: volume, temperature a pressure and/or density.

The determined corrective quantity of gas may possibly also vary according to the temperature of the gas in the tank 2 that is to be filled or in the filling pipe 4.

The determined corrective quantity of gas may possibly vary according to the (known or measured) volume of the tank 2, and/or according to the known or measured volume of the filling circuit 4.

The determined corrective quantity of gas may be the calculated or measured quantity of gas discharged via the purge valve 10, or a fraction of this quantity.

For example, the quantity of gas purged may be estimated from the volume contained in the circuit 4 between the downstream isolation valve 6 and the downstream end 8, from the pressure 15 measured in this part of the circuit 4, from the measured or estimated temperature in this part of the circuit 4, from the characteristics of the gas (its nature, its molar mass . . . ), and from the final pressure in the pipe 4 after the transfer step and after the purge step. On the basis of these parameters, the density and/or the mass of gas purged can be calculated.

For example, the determined corrective quantity of gas is calculated by a state equation (perfect-gas or real-gas equation) applied to the gas in the downstream part of the filling pipe before the purge step and after the purge step on the basis of the following parameters: the known volume of the filling pipe downstream of the downstream isolation valve 6, the measured final pressure in the tank 2 that is to be filled or in the filling pipe 4 at the end of the transfer step before the purge step, the measured or estimated temperature of the gas in the tank 2 that is to be filled or in the filling pipe 4, the known nature of the gas and notably its molar mass, the pressure in the filling pipe 4 after the purge step. The corrective quantity may be the result of the difference between the calculated quantity of gas present in the downstream part of the filling pipe 4 before the purge step and the calculated quantity of gas present in the in the downstream part of the filling pipe 4 after the purge step.

As illustrated in FIG. 2, the station may comprise a second, purge, flow meter 11 situated downstream of the purge valve 10 and configured to measure the quantity of gas purged during the purge step. The determined corrective quantity of gas is, for example, the quantity of gas measured by the purge flow meter 11, or a determined fraction of this quantity.

As indicated schematically in the figures, the electronic data processing and storage device 12 may comprise or be associated with a pulse counting member 16 and a member 17 for correcting the counted pulses (this or these member(s) 16, 17 may comprise electronic circuit boards or any other suitable device).

Of course, the filling circuit 4 may comprise other elements and notably other valve(s) 7 upstream or downstream of the downstream isolation valve 6 and/or a buffer volume between the flow meter 9 and the downstream isolation valve 6, an exchanger 19 for cooling the gas downstream of the downstream isolation valve 6, etc.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising,” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

An references identified herein are each hereby incorporated by reference into this application in their entireties, as well as for the specific information for which each is cited.

1-16. (canceled)

17. A method for measuring the quantity of gas introduced into a gas tank via a filling station equipped with a filling pipe that comprising an upstream end connected to at least one source of pressurized gas and a downstream end connected to a tank that is to be filled, the filling pipe comprising a flow meter and at least one downstream isolation valve positioned between the flow meter and the downstream end of the filling pipe, said method comprising the steps of transferring gas from the source to the tank during which step the downstream isolation valve is open;
interrupting the transfer of gas with closure of the downstream valve;
measuring, using the flow meter, a quantity of gas transferred during the transfer step; and
generating a signal indicating a corrected quantity of gas transferred, the corrected quantity of gas transferred being obtained by reducing or by increasing, by a determined corrective quantity, the measured quantity of gas transferred during said step of transferring, the flow meter being adapted and configured to generate electric signals in the form of successive pulses each corresponding to an elementary measured quantity of gas, the generated signal being obtained by modifying at least one: a value of the elementary quantity of gas corresponding to a pulse generated by the flow meter, a number of pulses generated by the flow meter, a frequency with which the pulses generated by the flow meter are emitted, and a number of pulses counted from the pulses generated by the flow meter.

18. The method of claim 17, wherein the generated signal is obtained by subtracting, or by adding, a determined quantity of pulses from or to the pulses generated by the flow meter.

19. The method of claim 17, wherein said step of modifying is performed by modifying, up or down, the frequency of the pulses generated by the flow meter by removing or by adding a determined length of time from or to a time interval separating successive pulses generated by the flow meter.

20. The method of claim 17, wherein the determined corrective quantity of gas is a determined proportion of the quantity of gas measured by the flow meter during the transfer step.

21. The method of claim 20, wherein the determined proportion is fixed and independent of operating conditions of said method.

22. The method of claim 20, wherein the determined portion is variable and dependent on operating conditions of said method.

23. The method of claim 17, wherein the filling pipe comprises, downstream of the downstream isolating valve, a controlled purge valve, the method further comprising a step of purging to outside the filling pipe at least some of the pressurized gas trapped in the downstream part of the filling pipe after said step of transferring.

24. The method of claim 23, wherein the determined corrective quantity of gas is a determined percentage of the quantity of gas discharged during the purge step.

25. The method of claim 24, wherein the percentage varies according to pressure measured in the transfer line during said step of transferring and said percentage is calculated regularly at an end of said step of transferring.

26. The method of claim 25, wherein the percentage is proportional to the pressure in the transfer line.

27. The method of claim 25, wherein the percentage is proportional to the difference (P−Pi) between, on the one hand, the pressure (P) in the transfer line as measured during the transfer step or the end of the transfer step and, on the other hand, the pressure (Pi) in the transfer line after the purge step.

28. The method of claim 23, wherein the percentage is between 95% and 75%.

29. The method of claim 24, wherein the percentage is between 95% and 75%.

30. The method of claim 22, wherein the filling pipe comprises a purge flow meter configured to measure the quantity of gas discharged during the purge step.

31. The method of claim 18, wherein the modification step is performed during the transfer step, notably in a way that is temporally uniformly distributed through the transfer step or at the end or after the end of the transfer step.

32. The method of claim 17, wherein the filling station comprises an electronic data processing and storage device comprising a microprocessor and/or computer, said electronic device being configured to receive a signal indicative of the quantity of gas transferred as measured by the flow meter during the transfer step and to calculate and/or receive and/or transmit and/or display the signal indicating the corrected quantity of gas transferred.

33. The method of claim 17, wherein the signal indicating the corrected quantity of gas transferred is used in a step of calculating the charge to be made for the quantity of gas introduced into the tank.

34. A filling station for filling pressurized-fluid tanks, notably for filling pressurized hydrogen tanks, comprising a filling pipe and an electronic data processing and storage device, wherein:
said filling pipe comprises an upstream end connected to at least one source of pressurized gas and at least one downstream end intended to be connected to a tank that is to be filled, a flow meter, and at least one downstream isolation valve positioned between the flow meter and the downstream end of the filling pipe;
the at least one valve being operable in such a way as to allow a step of transferring gas from the source to the tank;
the flow meter is adapted and configured to measure the quantity of gas transferred and to generate a first signal corresponding to said quantity of gas transferred;
the electronic data processing and storage device comprises a microprocessor and/or computer that is adapted and configured to receive the first signal and to generate a second signal that is indicative of a corrected quantity of gas transferred, the corrected quantity of gas transferred being obtained by reducing, or by increasing, by a determined corrective quantity, the measured quantity of gas transferred;
the flow meter is further adapted and configured to generate electric signals in the form of successive pulses each corresponding to an elementary measured quantity of gas;
the second signal is obtained by modifying at least one of: a value of the elementary quantity of gas corresponding to a pulse generated by the flow meter, a number of pulses generated by the flow meter, a frequency with which the pulses generated by the flow meter are emitted, and a number of pulses counted from the pulses generated by the flow meter.
